(19) United States
(12) Patent Application Publication
(10) Pub. No.: US 2025/0333981 A1
(43) Pub. Date: Oct. 30, 2025

(54) LOCKING DEVICE FOR BI-FOLD DOORS

(71) Applicant: William Woodward, Baltimore, MD (US)

(72) Inventor: William Woodward, Baltimore, MD (US)

(21) Appl. No.: 18/826,353

(22) Filed: Sep. 6, 2024

Related U.S. Application Data
(60) Provisional application No. 63/537,216, filed on Sep. 8, 2023.

(51) Int. Cl. E05B 65/00; E05B 65/48

(52) U.S. Cl. CPC E05B 65/0085; E05B 65/48

(57) ABSTRACT

The present invention is a bi-folding door locking arrangement comprising: a pin; a first member rotatably attached to the pin; a second member rotatably attached to the pin having an aperture; and a third member rotatably attached to the pin having a loop positioned and sized to fit through the aperture.

### CROSS-REFERENCE TO RELATED APPLICATIONS

This application is a continuation-in-part (and claims the benefit of priority under 35 USC 120) of U.S. application No. 63/537,216 filed Sep. 8, 2023, currently pending. The disclosure of the prior applications is considered part of (and is incorporated by reference in) the disclosure of this application.

### BACKGROUND OF THE INVENTION

The present invention relates to a lock or latch for a door, and more particularly a lock or latch for a bi-folding door or panel latch.

Through the centuries, many devices and methods have been used for locking, or otherwise securing, hinged panels, such as single or double swinging doors, windows, or shutters in a frame, or jamb, to preclude entry into, or egress from, one space from another, to thereby provide security and/or protection from the elements. A number of factors must be taken into consideration in the design of such locking arrangements and their manner of operation.

A primary consideration is that the locking arrangement must, indeed, provide adequate security against forcible entry, when the locking arrangement is deployed. Through the years, it has thus become known to provide locking arrangements having more than one lock-point, in the form of dead-bolts, shoot-bolts, locking tongues, and/or hook-type latches, and the like, for engaging the jamb or frame surrounding the hinged panel, or for engaging an adjacent panel in a French door arrangement. It has also become common practice to include some form of latch mechanism, in the locking arrangement, for holding a door, or doors, in a closed but unlocked state, to provide protection from the elements, or entry of insects, or other vermin, into a space protected by the closed panel.

Another primary consideration, in the design of locking arrangements, is that they be conveniently and intuitively operable. For example, it is desirable that a locking arrangement be operable through manipulation of a minimal number of input elements, such as handles, thumb-turns, or keyed lock cylinders. This is particularly true with regard to locking arrangements having multiple lock-points in single or double-hinged panel arrangements. In a locking arrangement having multiple lock-points, for example, it is desirable that operation of all lock-points can be accomplished through manipulation of one, or at most two, input elements, given the fact that a person operating the locking arrangement has only two hands with which to simultaneously operate various input elements such as handles and thumb-turns. Intuitive operation of a minimum number of input elements can be especially critical in emergency situations, where a person, inside of a space secured by the locking arrangement, may need to quickly exit the space in the dark, or in reduced visibility situations caused by smoke in the case of a fire within the space, for example.

It is desired to have a locking arrangement and method for operating the locking arrangement in bi-folding doors and panels that is adjustable, easy to install, and allows for secure latching of the bi-folding doors or panels.

### SUMMARY

Accordingly, it is an objective of the present invention.

In a first embodiment the present invention is a bi-folding door locking arrangement comprising: a pin; a first member rotatably attached to the pin; a second member rotatably attached to the pin having an aperture; and a third member rotatably attached to the pin having a loop positioned and sized to fit through the aperture.

In a second embodiment the present invention is a bi-folding door locking arrangement comprising: a first member having a first portion of a locking mechanism; and a second member having a second portion of a locking mechanism, wherein the first member and the second member are hinged together and are rotatable about a hinged point and wherein the first portion of the locking mechanism interfaces with the second portion of the locking mechanism.

In a third embodiment the present invention is a bi-folding door locking arrangement comprising: a first member; a second member rotatably connected to the first member, wherein the second member has an aperture; and a third member rotatably connected to the first member and the second member and having a closed loop attached to the third member positioned to fit through the aperture of the second member.

### BRIEF DESCRIPTION OF THE DRAWINGS

FIG. 1 depicts a front isometric view of a lock, in accordance with one embodiment of the present invention.

FIG. 2 depicts a rear isometric view of a lock, in accordance with one embodiment of the present invention.

FIG. 3 depicts an isometric view of the lock installed on a door, in accordance with one embodiment of the present invention.

FIG. 4 depicts a front isometric view of a lock, in accordance with another embodiment of the present invention.

FIG. 5 depicts a rear isometric view of a lock, in accordance with another embodiment of the present invention.

FIG. 6 depicts an isometric view of the lock installed on a door, in accordance with another embodiment of the present invention.

FIG. 7 depicts an isometric view of the lock installed on a door, in accordance with another embodiment of the present invention.

### DETAILED DESCRIPTION OF THE INVENTION

The present invention provides a device and method of operating that allows for a bi-folding door or panel setup to be locked or latched. Through the use of the locking device a bi-folding or panel setup can be secured where typically no locking mechanism could be effectively implemented. The present invention provides various advantages over the present locking mechanisms available. Typically, bi-folding doors or panels (hereinafter “panels”) are secured at one end, and the panels are secured together by a set of hinges. This design makes it very difficult to lock or latch the panels closed.

The present designs either have a locking mechanism built into the hinge, a component that slides over the top of the panels, or a locking mechanism needs to be installed into the door frame and latches with the panel. Each of these designs are flawed. The present invention provides an advantage over these flawed designs in the simplicity of the installation and the effectiveness of the locking mechanism with providing minimum damage to the panels.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

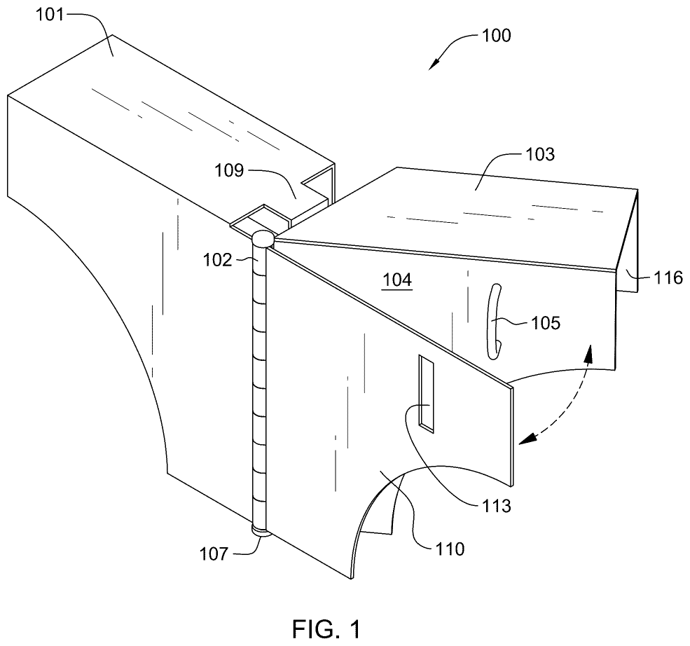

FIGS. 1-3 depict locking device 100, in accordance with the embodiments of the present invention.

The locking device 100 is comprised of sections 101, 103, and 111. These sections have knuckles 102 which are sized to receive a pin 107. The sections 101, 103, and 111 are able to rotate about the pin 107. In additional embodiments, the connection means between the sections may be of different methods, and the hinge like design is shown for exemplary purposes, provided the sections are able to rotate independently about a fixed vertical axis. Each section has knuckles 102 which do not interfere or overlap with the other sections but are able to receive pin 107. Each of the sections 101, 103, and 111 have similar profiles as shown in the figures, wherein a front portion extends has a trapezoidal shape with curved sections for design. The profile of these sections may be of different designs and shapes, provided the function of the locking device 100 is not affected.

Section 111 is a flat section with an opening 113 positioned relative to loop 105. Section 111 is substantially flat and has knuckles 102 which are secured about pin 107.

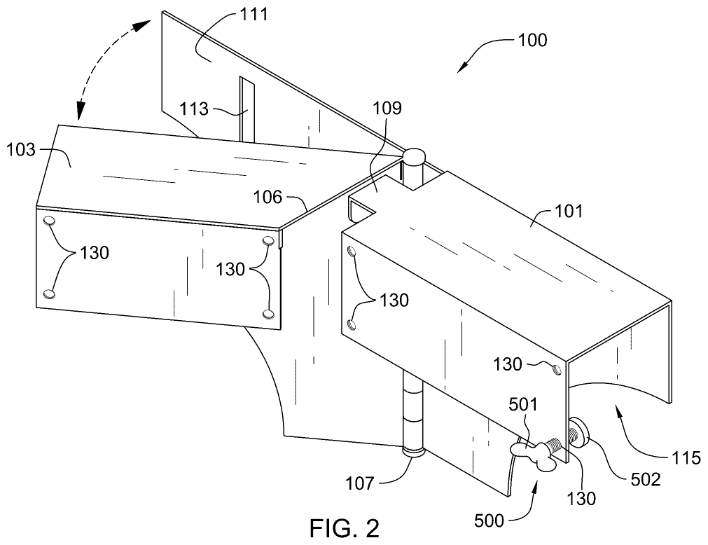

Section 103 has a “u” channel like shape with a flat surface 104 that has the loop 105 which aligns with the opening 113 so that the loop 105 can pass through the opening 113 when the locking device 100 is in the closed position. The opening of the “u” channel of section 103 is sized to receive the door 201 or 202. Sections 101 and 103 “u” channel shape 115 and 116 respectively are sized and shaped to receive the door or panel which the locking device 100 is used on. Section 103 has an inner edge 106 which is angled, so that when the door is opened, section 103 and section 101 do not obstruct one another. As shown in FIGS. 1-2, sections 101 and 103 when the hinge is in the open position do not interfere with one another given the angle of edge 106 and the length of the protrusion 109.

Section 101 has a “u” channel like shape with a protrusion 109 extending downward towards a bottom of the locking device 100. The opening of the “u” channel of section 101 is sized to receive the door 201 or 202. The protrusion 109 is sized and shaped to fit between the two panels of the door, so as to keep the locking device 100 centered about the hinge of the door, so that it cannot slide along the top edge of the door to circumvent the door. Section 101 “c” channel shape is sized and shaped to substantially mirror the shape and size of the door or panel which the locking device 100 is used on.

Along the rear surface of sections 103 and 101 are a series of threaded apertures 130. In the depicted embodiment, each section has four threaded apertures 130. In additional embodiments the sections 103 and 101 may have more or fewer threaded apertures 130 and they may be in different locations. The threaded apertures in the depicted figure are for exemplary purposes. A screw assembly 500 is shown inserted through one of the threaded apertures 130 and is comprised of a thumb screw 501 and a pad 502. The screw assembly 500 is used to secure the locking device 100 to the door or panel, as the user can tighten or loosen the screw assembly, so the locking device is in the desired position, and allows for the locking device to be universal with a plurality of different door shapes or sizes. The screw assembly 500 may have different lengths or shapes, and the screw assembly shown is for exemplary purposes.

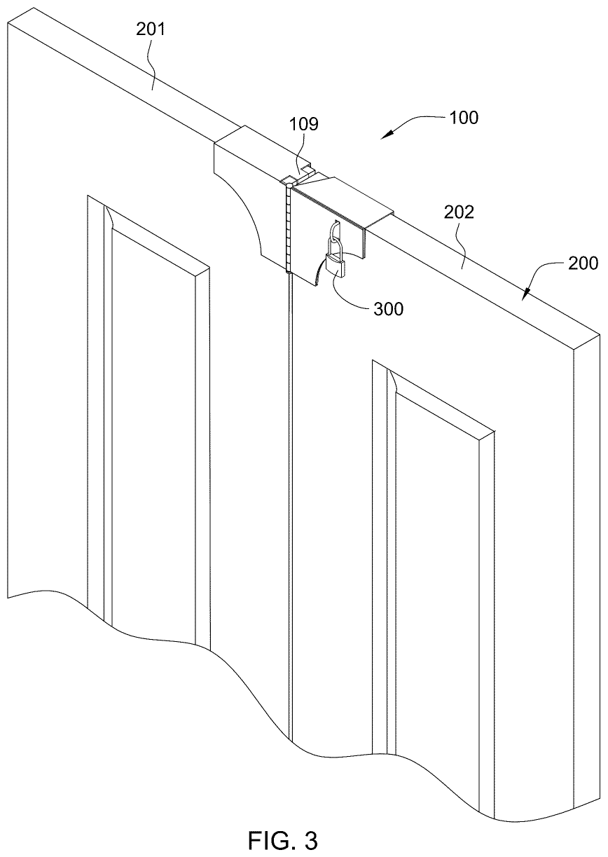

As shown in FIG. 3 The locking device 100 is in the “locked” position with a lock 300 attached to loop 105 and the protrusion 109 situated between panels 202 and 201. The door 200 cannot be opened, and the locking device 100 cannot be moved. The pin 107 of the locking device 100 substantially aligns with the hinges of the door 200, so that both the doors and the locking device 100 open and close without interfering with one another.

In some embodiments, the locking device 100 has an integrated locking mechanism, so that the extra lock 300 is not needed. In some embodiments, section 110 is fixed, and sections 101 and 103 are rotatable.

In some embodiments, the sections 101 and 103 have a “c” channel shape that is sized based on the dimensions and contour of the doors 201 and 202. This “c” channel shape is an example, as the shape can vary based on the door 200 and the panel 201 and 202 design.

The locking device 100 is installed, by opening the door 200, so that sections 101 and 103 can fit over the respective panels of the door. The locking device 100 is then slid into position so that protrusion 109 interfaces with the panel 201. The screw assembly 500 is then tightened so that the locking device 100 is properly fit onto each panel. The door is closed, and the loop 105 fits through opening 113 and the lock 300 is attached. In some embodiments, padding or inserts are placed in the “u” channel to allow for use on various sized doors.

The locking device 100 and its components may be made from, but not limited to polyethylene, polyethylene terephthalate, high-density polyethylene, polypropylene, polystyrene, polyvinyl chloride, polyurethane, poly carbonate, polybutylene terephthalate, acrylonitrile styrene acrylate, acrylics, aluminum, steel, cooper, various other metals, a combination of plastics and metals, or the like or a combination of different materials.

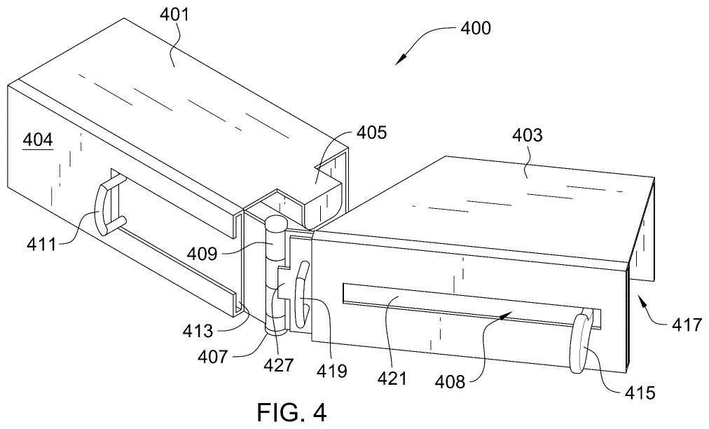

As shown in FIGS. 4-7, a locking device 400 is shown, in accordance with another embodiment of the present invention.

The locking device 400 is comprised of sections 401 and 403. These sections have knuckles 409 which are sized to receive a pin 407. The sections 401 and 403 are able to rotate about the pin 407. In additional embodiments, the connection means between the sections may be of different methods, and the hinge like design is shown for exemplary purposes, provided the sections are able to rotate independently about a fixed vertical axis. Each section 401 and 403 has knuckles 409 which do not interfere or overlap with the other sections but are able to receive pin 407, so that both sections 401 and 403 are able to rotate about the pin 407 freely.

Section 401 has a “u” channel like shape with a protrusion 409 extending downward towards a bottom of the locking device 400 on an inside edge of section 401. The opening of the “u” channel of section 401 is sized to receive the door 201 or 202. The protrusion 409 is sized and shaped to fit between the two panels of the door, so as to keep the locking device 400 centered about the hinge of the door. So that the locking device 400 cannot slide along the top edge of the door to circumvent the lock. A slot 413 is present on the front 404 of section 401 which extended a predetermined distance along the front 404 of the section 401. At the end of the slot 413 is a loop 411 which extends forward away from the front 404. The slot 413 is sized and shaped to replace plate 421.

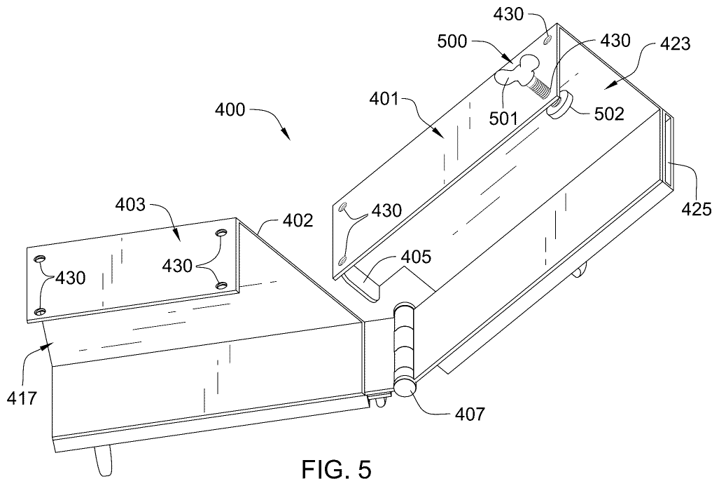

Section 403 has a “u” channel like shape with a slot where plate 421 fits within. The opening of the “u” channel of section 403 is sized to receive the door 201 or 202. Plate 421 has a loop 419 at a first end and a tab 415 at a second end. In the depicted embodiment at the first end, an extrusion 427 is present which is a guide so that the plate 421 slides into the loop 411. The tab 415 is fit within a channel 408 of a predetermined length and is sized to fit the tab 415 without interference. Section 403 has an inner edge 402 which is angled, so that when the door is opened, section 403 and section 401 do not obstruct one another. As shown in FIGS. 4-5, sections 401 and 403 when the hinge is in the open position do not interfere with one another given the angle of edge 106 and the length of the protrusion 109.

Along the rear surface of sections 406 and 407 are a series of threaded apertures 130. In the depicted embodiment, each section has four threaded apertures 130. In additional embodiments the sections 406 and 407 may have more or fewer threaded apertures 130 and they may be in different locations. The threaded apertures in the depicted figure are for exemplary purposes. A screw assembly 500 is shown inserted through one of the threaded apertures 130 and is comprised of a thumb screw 501 and a pad 502. The screw assembly 500 is used to secure the locking device 100 to the door or panel, as the user can tighten or loosen the screw assembly, so the locking device is in the desired position, and allows for the locking device to be universal with a plurality of different door shapes or sizes. The screw assembly 500 may have different lengths or shapes, and the screw assembly shown is for exemplary purposes.

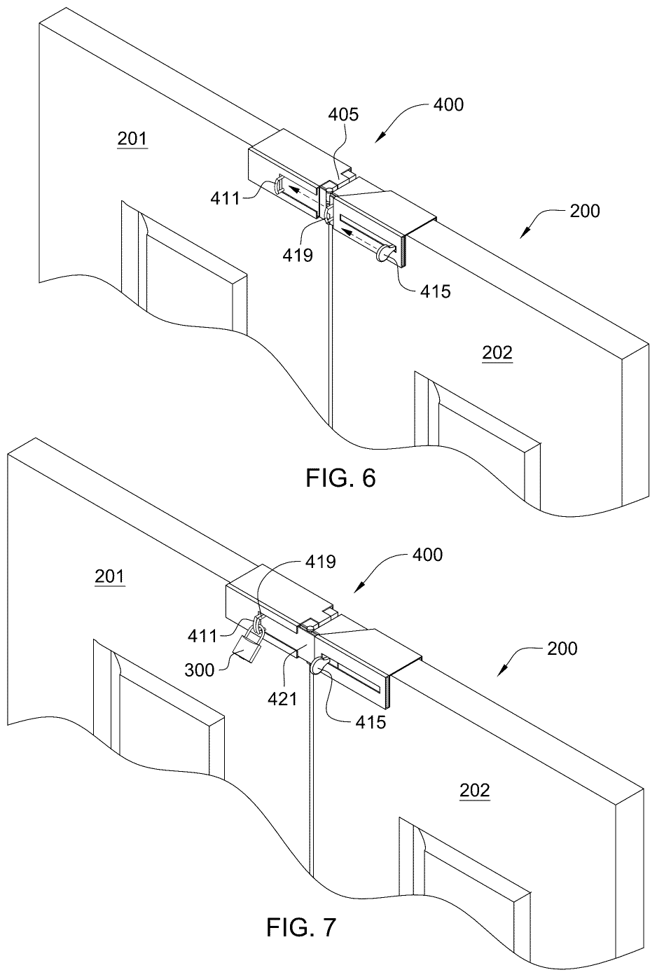

As shown in FIGS. 6 and 7 the locking device 400 is shown in the “unlocked” and in the “locked” positions with a lock 300 attached to loops 411 and 419 and the protrusion 405 situated between panels 202 and 201. The door 200 cannot be opened, and the locking device 400 cannot be moved. The pin 407 of the locking device 400 substantially aligns with the hinges of the door 200, so that both the doors and the locking device 400 open and close without interfering with one another. As shown the hinge does not interfere with the plate 421 when in the closed position.

In some embodiments, the locking device 400 has an integrated locking mechanism, so that the extra lock 300 is not needed and loops 411 and 419 are able to be secured in a locked position.

In some embodiments, the sections 401 and 403 have a “c” channel shape that is sized to match the dimensions and contour of the doors 201 and 202. This “c” channel shape is an example, as the shape can vary based on the door 200 and the panel 201 and 202 design. Sections 401 and 403 “u” channel shape 423 and 417 respectively are sized and shaped to receive the door or panel which the locking device 400 is used on. In some embodiments, padding or inserts are placed in the “u” channel to allow for use on various sized doors.

The locking device 400 is installed, by opening the door 200, so that sections 401 and 403 can fit over the respective panels of the door. The locking device 400 is slide so that protrusion 405 interfaces with the panel 201. The screw assembly 500 is then tightened so that the locking device 100 is properly fit onto each panel. The door is closed, and tab 415 is used to slide the plate 421 all way until loops 411 and 419 are close enough for the lock 300 to be attached to both loops, and then locked.

The locking device 400 and its components may be made from, but not limited to polyethylene, polyethylene terephthalate, high-density polyethylene, polypropylene, polystyrene, polyvinyl chloride, polyurethane, poly carbonate, polybutylene terephthalate, acrylonitrile styrene acrylate, acrylics, aluminum, steel, cooper, various other metals, a combination of plastics and metals, or the like or a combination of different materials.

While this invention has been described in conjunction with the specific embodiments outlined above, it is evident that many alternatives, modifications, and variations will be apparent to those skilled in the art. Accordingly, the preferred embodiments of the invention, as set forth above, are intended to be illustrative, not limiting. Various changes may be made without departing from the spirit and scope of this invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A bi-folding door locking arrangement comprising:
a pin;
a first member rotatably attached to the pin;
a second member rotatably attached to the pin having an aperture; and
a third member rotatably attached to the pin having a loop positioned and sized to fit through the aperture.

2. The bi-folding door locking arrangement of claim 1, further comprising a tab extending from a first edge and a top surface of the first member.

3. The bi-folding door locking arrangement of claim 1, wherein the first member and the second member have a “u” channel design.

4. The bi-folding door locking arrangement of claim 3, wherein the “u” channel design is relative to a width of the bi folding door.

5. The bi-folding door locking arrangement of claim 1, wherein a first edge of the second member is not perpendicular to a second edge.

6. The bi-folding door locking arrangement of claim 1, further comprising a series of apertures on a second surface of the first and third members.

7. The bi-folding door locking arrangement of claim 6, further comprising a thumb screw inserted through the series of apertures.

8. A bi-folding door locking arrangement comprising:
a first member having a first portion of a locking mechanism; and
a second member having a second portion of a locking mechanism, wherein the first member and the second member are hinged together and are rotatable about a hinged point and wherein the first portion of the locking mechanism interfaces with the second portion of the locking mechanism.

9. The bi-folding door locking arrangement of claim 8, wherein the first member along a first edge has an extension, wherein the extension extends downwards a predetermined distance.

10. The bi-folding door locking arrangement of claim 8, wherein the second member has a first edge and a second edge which are not perpendicular.

11. The bi-folding door locking arrangement of claim 8, wherein the first member has a first slot positioned relative to the first portion of the locking mechanism.

12. The bi-folding door locking arrangement of claim 11, wherein the second member has a second slot positioned relative to the first slot.

13. The bi-folding door locking arrangement of claim 12, wherein the second portion of the locking mechanism comprises a plate positioned within the second slot.

14. The bi-folding door locking arrangement of claim 13, wherein the plate has a loop attached to a first end, and a tab attached to a second end.

15. The bi-folding door locking arrangement of claim 14, wherein the second member has a slot along a first surface and the tab is secured within the slot.

16. The bi-folding door locking arrangement of claim 14, wherein the first end has profile, wherein the profile is based on the first portion of the locking mechanism design.

17. The bi-folding door locking arrangement of claim 8, wherein the first member and the second member have “u” channel shape, and wherein the “u” channel is based on the bi-folding door width.

18. A bi-folding door locking arrangement comprising:
a first member;
a second member rotatably connected to the first member, wherein the second member has an aperture; and
a third member rotatably connected to the first member and the second member and having a closed loop attached to the third member positioned to fit through the aperture of the second member.

19. The bi-folding door locking arrangement of claim 18, wherein the first member, the second member, and the third member are all rotatable about a vertical axis.

20. The bi-folding door locking arrangement of claim 18, wherein the first member and the third member have a “u” channel design, and wherein the u″ channels of the first member and the third member are able to align.
